(19) United States
(12) Patent Application Publication
(10) Pub. No.: US 2007/0132943 A1
(43) Pub. Date: Jun. 14, 2007

(54) Multipart Sunglasses

(76) Inventor: Nathan Kurzrok, Northbrook, IL (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/674,740

(22) Filed: Feb. 14, 2007

Related U.S. Application Data
(63) Continuation-in-part of application No. 11/215,471, filed on Aug. 29, 2005, now Pat. No. 7,195,350.

(51) Int. Cl. G02C 9/00

(52) U.S. Cl. 351/47

(57) ABSTRACT

A multipart sunglass device includes a frame having an integrated nosepiece. A semitransparent, polycarbonate sunglass lens is mounted to the frame. The frame completely encloses a side surface of the sunglass lens. The sunglass lens extends vertically from a top surface of the frame to a first position corresponding to a location just below the pupil of the eye of a wearer. A transparent, refractive lens is coupled to a bottom surface of the sunglass lens corresponding with the first position. The sunglass lens and the refractive lens are joined at a distinct separation zone, allowing the wearer to view objects having a focal position lower than the first position without any obstruction, filtration or absorption of light, yet view the objects subject to a refractive property of the refractive lens.

### CROSS-REFERENCE TO RELATED APPLICATIONS

The present application is a continuation-in-part application of prior U.S. nonprovisional application “Multiview Eyeglasses,” Ser. No. 11/215,471, filed Aug. 29, 2005, and claims priority of the foregoing application under 35 U.S.C. 120.

### FIELD OF THE INVENTION

The present invention relates in general to a device with multipart lenses, and more particularly, to multipart lenses which permit a wearer to see anything within his field of view in filtered, reduced, or modified light, and then by simply moving his eyes or head, view the same object or other objects then within his view through a clear lens, a prescription lens, through any other light modifying lens, or through no lens at all.

### BACKGROUND OF INVENTION

A vast variety of sunglasses and other lenses with optical filtration have been developed and introduced. Many of the recent improvements to sunglasses have concerned changes in the design of the frames to make the sunglasses more comfortable to wear. Additionally, several decorative frame designs have been introduced. A number of improvements to sunglass lenses have also been introduced. The improvements related to sunglass lenses generally have concerned the optical properties of the lenses, including filtration and technologies to reduce the intensity of light, such as polarizing lenses which serve to remove glare.

Sunglasses and other devices have evolved to successfully and efficiently accomplish a variety of purposes. Sunglasses, for example, can remove harmful ultraviolet (UV) rays from viewed sunlight. Sunglasses can provide protection from light and glare by modifying the physical properties of the light as the light passes through a lens.

Many individuals wear sunglasses or similar devices while driving a vehicle, operating a boat, controlling machinery and the like. Many of these lenses distort the field of view and/or reduce the amount of light passing through the eye, thereby interfering with the ability of a user to read, see and understand an instrument panel, discern a navigation screen, read a sign, view a map with associated text or participate in any other activity requiring a greater amount of the available light and a less distorted view. While conventional sunglasses work well at reducing outside light and glare, a user may have difficulty viewing objects either in close proximity to the user or at a distance while wearing conventional sunglasses. The user may have to physically remove his sunglasses while participating in any of the aforementioned activities to better see the object or light source he is trying to view. For example, a user may experience difficulty reading a map or driving instructions scribbled on a piece of paper without removing his sunglasses. The chore of continually removing and replacing sunglasses to view an object can become tiresome and, in some cases, dangerous.

A need exists for an apparatus which allows for optical filtration of light yet allows a user to concurrently view objects and light sources which require a greater amount of available light or/and a less distorted view.

### SUMMARY OF THE INVENTION

In one embodiment, the present invention is a multipart sunglass device, comprising a frame including an integrated nosepiece, a semitransparent sunglass lens mounted to the frame, the frame completely enclosing a side surface of the sunglass lens, wherein the sunglass lens extends vertically from a top surface of the frame to a first position corresponding to a location just below the pupil of the eye of a wearer, and a transparent, refractive lens coupled to a bottom surface of the sunglass lens corresponding with the first position, wherein the sunglass lens and the refractive lens are joined at a distinct separation zone, allowing the wearer to view objects having a focal position lower than the first position without any obstruction, filtration or absorption of light, yet view the objects subject to a refractive property of the refractive lens.

In another embodiment, the present invention is a multipart sunglass device, comprising a frame and nosepiece apparatus, and a sunglass lens having a semitransparent portion and a clear, refractive portion, the sunglass lens mounted to the frame, wherein the semitransparent portion of the sunglass lens is selected to block or absorb 70 to 90 percent of light, incorporates a polarizing filter for filtering light reflecting off a horizontal surface, and extends vertically from a top surface of the frame to terminate at a first position corresponding to a location just below the pupil of the eye of a wearer, and the clear, refractive portion extends vertically from the first position to a bottom surface of the frame, the clear refractive portion and semitransparent portion joined at a distinct separation zone to allow the wearer to view objects having a focal position lower than the first position without any obstruction, filtration or absorption of light, yet view the objects subject to a refractive property of the clear, refractive portion of the sunglass lens.

In another embodiment, the present invention is a multipart sunglass device, comprising a frame connected to a nosepiece, a sunglass lens mounted to the frame and extending vertically from a top surface of the frame to a first position corresponding to a location just below the pupil of the eye of a wearer, and a clear, refractive lens coupled to a bottom surface of the sunglass lens at the first position to form a distinct separation zone, allowing the wearer to view objects at a focal position lower than the first position without any obstruction, filtration or absorption of light, yet view the objects subject to a refractive property of the clear, refractive lens.

In another embodiment, the present invention is a method of manufacturing a multipart sunglass device, comprising providing a frame including an integrated nosepiece, providing a semitransparent sunglass lens mounted to the frame, the frame completely enclosing a side surface of the sunglass lens, wherein the sunglass lens extends vertically from a top surface of the frame to a first position corresponding to a location just below the pupil of the eye of a wearer, and providing a transparent, refractive lens coupled to a bottom surface of the sunglass lens corresponding with the first position, wherein the sunglass lens and the refractive lens are joined at a distinct separation zone, allowing the wearer to view objects having a focal position lower than the first position without any obstruction, filtration or absorption of light, yet view the objects subject to a refractive property of the refractive lens.

### BRIEF DESCRIPTION OF THE DRAWINGS

FIG. 1a illustrates a pair of fully framed sunglasses having a lens with a first portion for filtering light and a second portion through which little or no filtration is undergone;

FIG. 1b illustrates the sunglasses shown in FIG. 1a with the first portion and the second portion in a reversed position;

FIG. 2a illustrates a pair of sunglasses in a separate example having a lens not completely surrounded by a frame;

FIG. 2b illustrates the sunglasses of FIG. 2a having a cut-out portion;

FIG. 3 illustrates an additional example of a pair of sunglasses having a lens with an associated clear portion;

FIG. 4 illustrates a pair of goggles having an associated clear portion;

FIG. 5 illustrates a pair of clip-on sunglasses;

FIG. 6a illustrates another example of clip-on sunglasses having an associated cut-out portion of the lens;

FIG. 6b illustrates the clip-on sunglasses of FIG. 6a having an associated cut-out portion of the lens, the lens shown in position over eyeglasses;

FIG. 7a illustrates a side view of a pair of sunglasses which are intended to be worn over existing eyewear;

FIG. 7b illustrates a front view of a pair of sunglasses which are intended to be worn over existing eyewear;

FIG. 8 illustrates a welding mask with an associated semitransparent portion and a clear portion;

FIG. 9 illustrates a face shield with an associated clear portion;

FIG. 10A illustrates a first example multipart sunglass device in a first view;

FIG. 10B illustrates the first example multipart sunglass device of FIG. 10A in an additional view;

FIG. 11A illustrates a second example multipart sunglass device in a first view; and

FIG. 11B illustrates the second example multipart sunglass device of FIG. 11A in an additional view.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

As found herein, the terms “filtration”, “filtered”, or “filter” as they relate to light are intended to refer to any physical modification of the light, such as reduction in intensity or energy or inhibition of a part of the spectrum. For example, a filter can work to reduce light or some wavelengths of the light passing through it. The term “semitransparent” as found herein is intended to refer to a physical state of an object allowing light to selectively pass, or to pass diffusely through the object. A lens can be said to be semitransparent to encompass a variety of physical characteristics, such as relating to a degree of shading or opaqueness of the lens.

A sunglass or a similar eyewear device featuring the optical filtration properties of a light reducing or semitransparent lens, but serving to eliminate the problems described above, can be constructed. The semitransparent lens can include a transparent or clear portion of the lens which allows a wearer to view an object with substantially small or no filtration. Alternatively, a semitransparent lens may be constructed which includes a cut-out portion. The cut-out portion can serve the same purpose as a transparent, clear portion of a lens. A user can examine objects such as an instrument panel, a road sign, a map or book without obstruction or filtration of the view. A lens with a transparent or clear portion or cutout as described can be applied to a variety of similar devices, including goggles, masks, shields, clip-on sunglasses and other devices.

A device can be constructed which includes a sunglass lens (semitransparent and/or filtered lens) for each eye which surrounds or is located above a clear lens. The sunglass lens, or primary lens, can distort the field of view. The sunglass or primary lens can also reduce the amount of light passing through the lens. The clear lens, or secondary lens, can permit a user to see the same object, or other objects within the user's field of view without distortion or change and without a reduction in the amount of light passing through the secondary lens. The secondary lens can be a lens with optical characteristics which can reduce, filter, or modify the light traveling through the secondary lens. Again, the secondary lens could be no lens at all, and can be a cutout or open area of the device. In one example, the primary or sunglass lens shades the pupil of the eye when the head of a user is moved, or the eye of a user is moved to better see around the primary lens portion of the device.

The color of the sunglass lens can vary by style, fashion, and purpose, but for general use, green, grey, or brown can be used to avoid or minimize color distortion, that could be dangerous when, for instance, driving a car. Grey lenses are considered neutral because they do not enhance contrast or distort colors. Brown and green lenses cause some minimal color distortion, but have contrast-enhancing properties. Red lenses are good for medium and lower light conditions because they are good at enhancing contrast but causes color distortion. Orange and yellow lenses have the best contrast enhancement and depth perception but cause color distortion. Yellow lenses are commonly used by golfers and shooters for contrast enhancement and depth perception properties. Blue and purple lenses offer no real benefits and are mainly cosmetic.

In one embodiment, lenses can have polarized lenses to reduce glare caused by light reflected from polarizing surfaces such as water as well as by polarized diffuse sky radiation.

A mirrored coating can also be applied to the sunglass lens. The mirrored coating reflects some of the light when the light hits the lens before the light is transmitted through the lens making the mirrored coating useful in bright conditions. Mirrored coatings can be made any color by the manufacturer for styling and fashion purposes. The color of the mirrored surface is irrelevant to the color of the lens. For example, a gray lens can have a blue mirror coating, and a brown lens can have a silver coating. Any of the above features: color, polarization, degradation, and mirroring, can be combined into a set of lenses for a pair of sunglasses.

When used as a sunglass, this device can replace the need normally satisfied by the user constantly moving, removing and replacing the sunglass from the sunglass normal position on the face in order for the user to better see such things as objects, text, and instruments that are not clear to the user when looking through the primary lens.

In one example, the device can be a sunglass whose primary element is a (a) light reducing lens having a shaped opening in the lens (the opening constituting the secondary lens) or (b) a light reducing lens which has another shaped opening disposed over the lens (the opening constituting the secondary lens) or (c) a light reducing lens which is shaped to shade the pupil of an eye while permitting the secondary lens to be absent or less light reducing. In all cases, the primary lens can be sufficient in size to permit shading of the pupil of the eye, while the open or clear portion is sufficient to allow the user to read maps, see signs, view a navigation screen or read an instrument panel without the reduction in light and/or distorted vision which traditional sunglasses characteristically produce.

The secondary lens or portion can be constructed of clear plastic or glass, or can be a prescription lens thereby forming a bifocal arrangement with the sunglass (primary) lens. A tertiary lens could be added between the sunglass (primary) and prescription (secondary) lenses to enhance vision at a different distance than the distance provided by the secondary lens. In addition, the primary, secondary and tertiary lens can all include a light refracting curvature reflective of a certain prescription or in order to facilitate the viewing of objects at a perceived closer distance than from where the objects appear normally (e.g., magnification of distant objects).

Another form of sunglass (primary) lens can be hemispherical in shape, somewhat like an awning over the eye, or can be a variety of other shapes. The bottom edge of the primary lens can be located essentially level with the bottom of the pupil. The bottom edge of the primary lens can shade the pupil, yet also permit sight beneath the bottom edge of the primary lens. The hemispherical shape can permit the reading of maps, signs, navigation devices, and other objects within the vision of a user while shading the eye from light.

The hemispherical primary lens can use an opaque hemispherical lens to shield a user's sight from sunlight, lamplight, or other sources of light, while allowing sight for reading, manipulation of mechanical instruments or tools, or other similar usages. Prescription lenses or other light modifying lenses (the secondary lens) could be attached below the hemisphere of the primary lens to enable better sight of a user. Again, the secondary lens can also incorporate independent eyeglass prescriptions. Where seeing of detail through the primary lens is unimportant, the exterior of the primary lens can be attractively decorated to make a fashion statement.

All of the above devices can be designed in an inverted fashion such that the primary lens reduces or removes light coming from below the eye. In the case of an inverted primary and secondary lens, the primary lens can extend from the bottom edge of the device, to below the level of the pupil. The top level of the primary lens would extend to a height level with, or above the upper edge of the pupil. Light or other phenomena is thereby reduced or eliminated from sources below the eye. Some of the materials used may be either common plastic or glass as used in sunglasses. However, other materials may be used to also resist the transmission of other phenomena such as heat or cold. In similar fashion, a face mask could be designed to incorporate the same design features as the devices described above.

Finally, the devices as described can be constructed to be foldable, such that a wearer can easily tuck the device into a shirt pocket when the use of the device is not longer required.

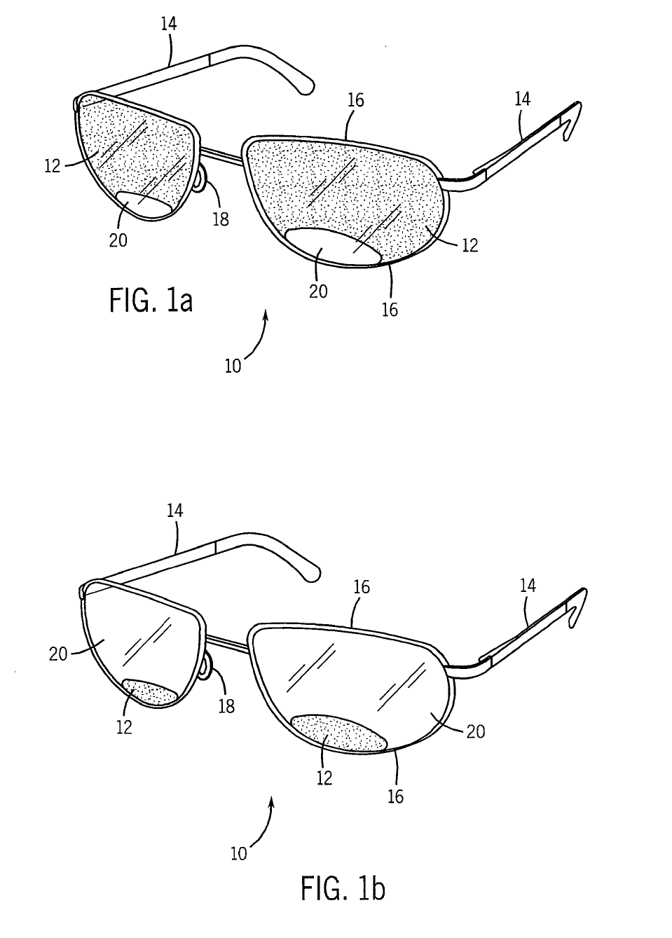

Turning to FIG. 1a, a pair of sunglasses 10 is shown in an example. Sunglasses 10 include primary lenses 12, arms 14 which are hooked around the ears, frames 16 which surround lenses 12 and nosepiece 18 which also attaches to frames 16. Frames 16 can be a support structure for lenses 12. Frames 16 can hold lenses 12 in place in a position over the eyes. Frames 16 and/or the accompanying support structure can extend over a large portion of a wearer's face in order to provide protection from flying debris or hazardous materials.

Primary lenses 12 have a semitransparent portion or primary lens which extends substantially over an upper portion of the lenses 12. The semitransparent portion of lenses 12 can function to filter light before the light enters the eye in a manner similar to conventional sunglasses. The semitransparent portion of lenses 12, in one example, can block or absorb 70 percent to 90 percent of light. The semitransparent portion of lenses 12 can reflect light by means of a reflective coating which is disposed over the surface of lenses 12. The semitransparent portion of lens 12 can have an associated tint. Examples of tints include gray, green, brown, amber, yellow, vermillion, orange and red tints. The associated tint of semitransparent portion of lens 12 can be selected to enhance or reduce color perception, contrast, acuity, glare or depth perception. The associated tint can be selected to promote vision in a particular setting or situation.

Located at a lower portion of lens 12 is a transparent, optically-clear portion 20 or secondary lens 20. Clear portion 20 is intended to not have the same degree of transparency associated with the semitransparent portion of lens 12. Clear portion 20 or secondary lens 20 can have substantially less or no filtration, reflection or absorption of light compared to the semitransparent portion of lens 12. Clear portion 20 can have substantially less or no associated tint.

As shown in FIG. 1, the level of transparency or tint changes at a distinct boundary or separation zone located at an upper periphery of clear portion 20.

Sunglasses 10 can be manufactured by any method known in the art. Lenses 12 can be composed of a variety of known materials, such as CR-39 plastic, polycarbonate, glass, or similar materials. Frames 16 and arms 14 can also be composed of a variety of known materials such as plastic, wire and high strength, light-weight composites or metals. Lenses 12 can incorporate a variety of known sunglass technologies such as tinting, polarization, photochromic technology, mirroring and coatings including scratch-resistant, anti-reflective and ultraviolet coating technologies. An example manufacturing process of sunglasses 10 can incorporate known injection molding or similar techniques.

The semitransparent portion of lens 12 can incorporate any or all of the above-mentioned technologies, while clear portion 20 can incorporate substantially less or none of the above-mentioned technologies. Again, the semitransparent portion of lens 12 can absorb, reflect and filter light, while clear portion 20 can absorb, reflect and filter substantially less or no light.

Although transparent, optically-clear portion 20 is shown having a sloping, curved shape, clear portion 20 can include any design. Clear portion 20 can be separated from the semitransparent portion of lens 12 by a straight line. The straight-line separation zone is distinct. In addition to being an integrated part of lens 12, clear portion 20 can be a cut-out portion 20 of lens 12. The design or shape of cut-out portion 20 can be similar to the design or shape of a clear portion 20 which is an integrated part of lens 12. In the case of a cut-out portion 20, a wearer can enjoy the benefit of filtered light through lens 12. What would constitute a lower portion of lens 12 is removed, allowing a user to have an unobstructed view of a close object or an associated viewing area through cut-out portion 20.

As previously mentioned, a wearer of sunglasses 10 having a clear or cut-out portion 20 enjoys a variety of benefits. A wearer can drive a vehicle with the benefit of a filtered view of the horizon, while still being able to read a navigation panel, view a map or discern a car stereo display. Similarly, a wearer of sunglasses 10 in a bright, sunlit occupational environment can use sunglasses 10 to block excess glare, filter harmful ultraviolet rays, etc., while still having the ability to read the display of a control panel through clear or cut-out portion 20.

A variation of clear portion 20 includes the use of refractive curvatures integrated into clear portion to refract light in a particular way. A prescription reading lens can be incorporated into clear portion 20 which refracts light in accordance with the prescription of the wearer.

FIG. 1b illustrates a version of sunglasses 26 which features an inverted primary and secondary lens portion as described above. Clear portion 20 is shown beginning at a position located just above the pupil of the eye and extending to the top of frames 16. Lens 12 is shown beginning at a position located just below the pupil and extending to the bottom of frames 16. A user can wear the eyeglasses 26 as shown in a situation where unimpeded sight is desired at and above a horizon, yet the user desires filtered or treated light to view a bright object below the horizon. Here, as before, clear portion 20 can form an integrated part of lens 12, constitute a secondary lens or portion or constitute a cut-out or opening portion, depending on the situation or use.

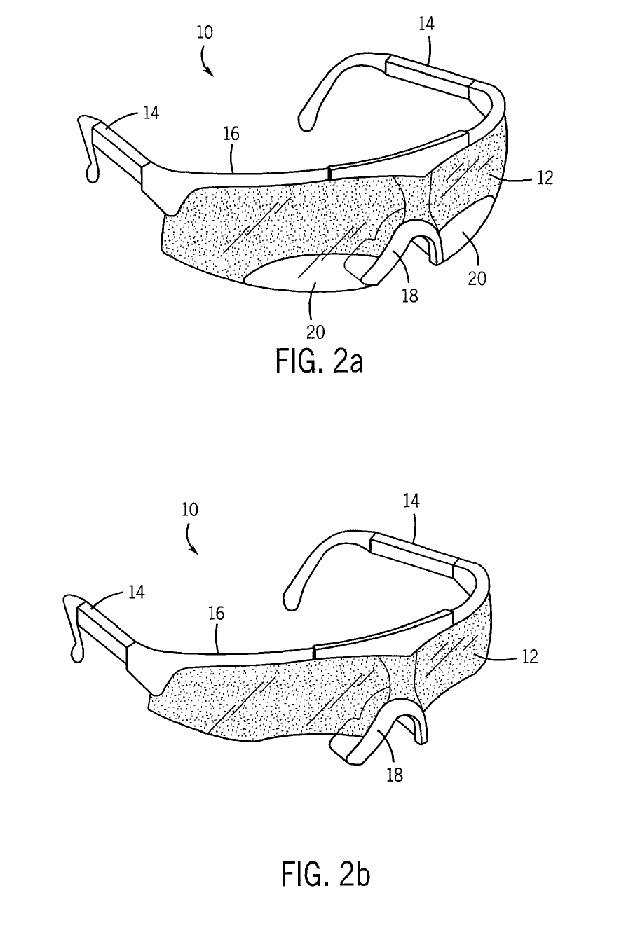

FIG. 2a illustrates another example of sunglasses 10. Frame 16 is seen along the top portion of lens 12. Lens 12 is unitary in construction, extending over nosepiece 18. Again, arms 14 are shown. Clear portions 20 are located at the lower periphery of lens 12. Again, a distinct dividing line or separation zone between the semitransparent portion of lens 12 and clear portion 12 is shown.

FIG. 2b illustrates the sunglasses 10 shown in FIG. 2a in a separate example where a cutout portion extends from the nosepiece 18 to an edge of lens 12. The cut-out or opening along the lower periphery of lens 12 can be designed to allow for a certain degree of unimpeded viewing depending on a specific situation or occupational requirement. As such, the cut-out can vary in shape and size depending upon need.

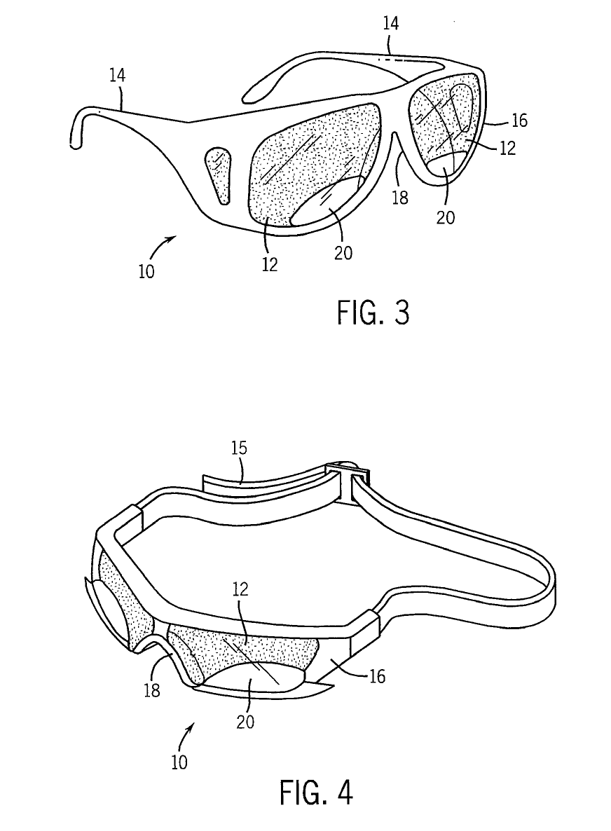

FIG. 3 shows another example of sunglasses 10 which can be placed over existing eyewear. Lens 12, which includes a semitransparent portion and clear portion 20 is again shown.

FIG. 4 illustrates a pair of sunglasses 10 which are depicted in goggle form. Goggles 10 include nosepiece 18, frame 16, and elastic or rubberized strap 15. Rubberized strap 15 can be adjusted such that lenses 12 and nosepiece 18 fit snugly against a wearer's face. Additionally, strap 15 can allow a wearer to participate in sports or other activities which would normally cause sunglasses 10 to fall off in the event of a sudden movement. Again, as shown, lenses 12 include clear portion 20.

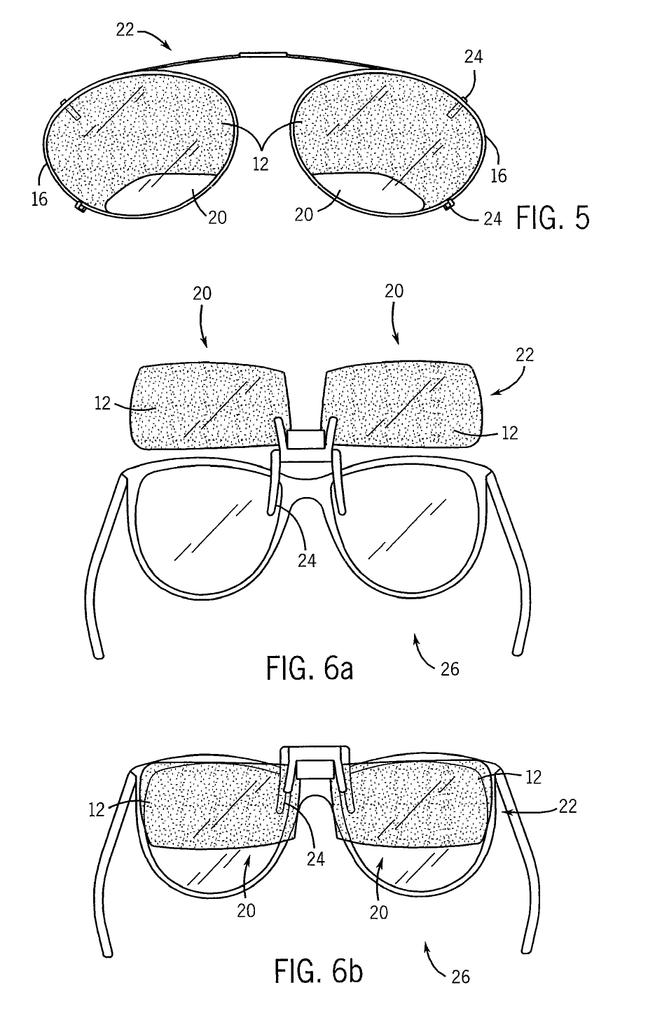

FIG. 5 illustrates an example featuring clip-on sunglasses 22. Clip-on sunglasses 22 include clips 24 which are intended to allow clip-on sunglasses 22 to mount to the external surface of existing glasses or other eyewear. Frame 16 again surrounds lenses 12. Clear portion 20 of lenses 12 are shown again located at a lower of lenses 12. FIG. 6a illustrates another clip-on sunglasses 22 example. Clip-on sunglasses 22 are shown mounted to eyeglasses 26 using clip 24. Lenses 12 are frameless, and terminate with clear portion 20 shown in a cut-out example. Cut-out example of clear portion 20 is shown with a straight line design as the distinct separation zone.

FIG. 6b illustrates clip-on sunglasses 22 showing lenses 12 folded down into position over eyeglasses 26. As can be seen, lenses 12 do not extend to cover the entire surface area of eyeglasses 26. A lower portion of the viewing area of eyeglasses 26 remains unobstructed, allowing a wearer to view filtered or otherwise treated light from the horizon while viewing objects below the upper horizon of the cut-out portion without obstruction, filtration, absorption or reflection of light.

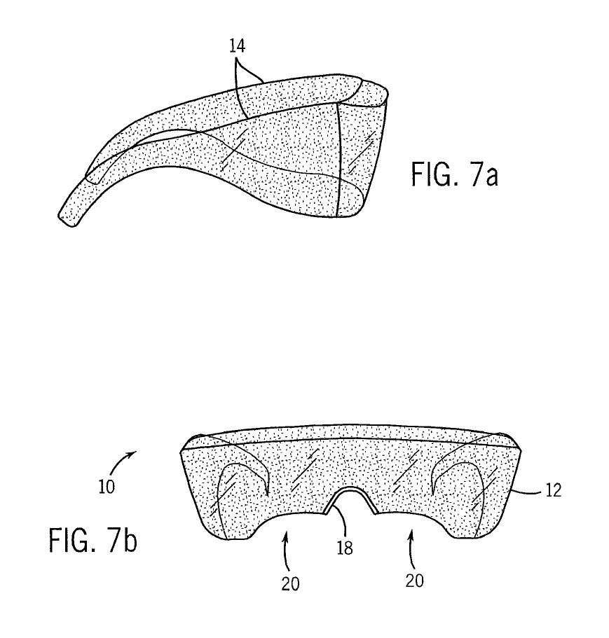

Sunglasses 10 shown in FIGS. 7a and 7b can also be worn over existing eyeglasses. Here, lens 12 and frame 16 are unitary in construction, and extend throughout the sunglasses 10. FIG. 4 illustrates a cut-out portion 20 of lens 12. Again, the cut-out portion 20 allows a user to view objects located below the upper horizon of the cut-out portion without obstruction or any filtration.

Lenses 12 can be used in a variety of occupational settings in combination with equipment which is intended to provide protection from flying debris, dangerous chemicals and other hazards. To protect their eyes from the actinic rays of welding flames, workers can wear face protection equipment. Machinists and other factory workers wear glasses or goggles of great strength to shield their eyes from flying particles of metal, and aviators and racing drivers wear goggles to shield their eyes from the wind. Watertight goggles permit divers to see under water.

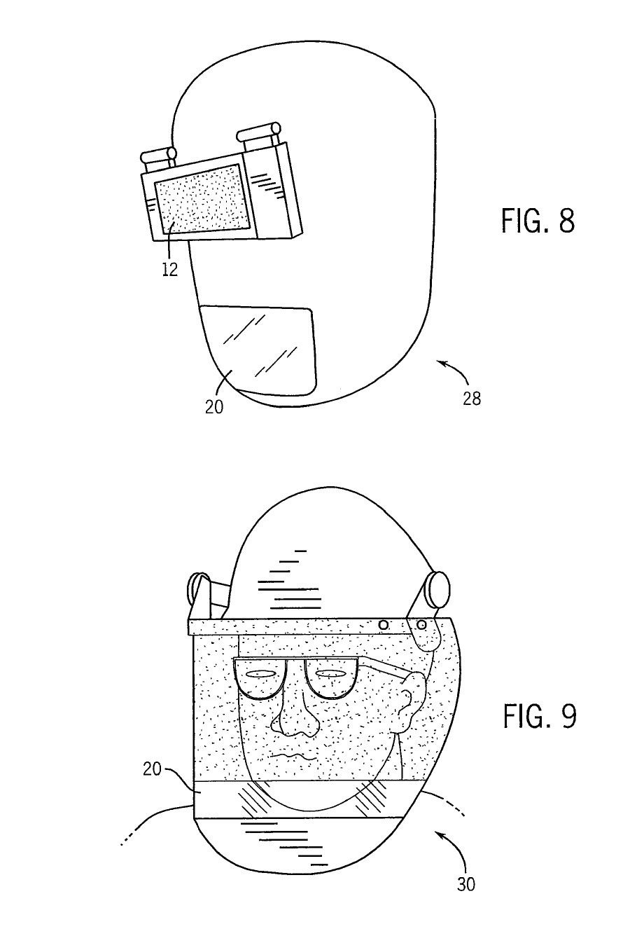

Lenses 12 can be adapted to fit a variety of the above-mentioned examples of occupational settings. In some cases, the support structure of lenses 12 can be adapted to include clear portion 20 to fit an occupational need. FIG. 8 illustrates a welding mask 28 which includes lenses 12. Clear portion 20 is located along a lower periphery of the support structure, or shield, of welding mask 28. Clear portion 20 can be composed of tough, shatterproof polycarbonate or a similar material which can protect a wearer from flying sparks and other debris. Clear portion 20 allows a user to look through clear portion 20 to view a weld or other work. A user can view a weld in progress and an associated electrical arc through darkly tinted lens 12. Once the user is finished welding, the user can view the completed weld thorough clear portion 20 without the need to lift the welding mask upwards or lift the lens 12 upwards to have an unobstructed view. The addition of clear portion 20 to the support structure of welding mask 28 allows a welder to accomplish work more efficiently.

In a similar fashion, FIG. 9 illustrates face shield 30 which is intended to cover a substantial portion of a face to provide protection. An upper portion of face shield 30 can have a variety of integrated tints, filters, coatings, etc. to provide filtration or otherwise inhibit light passage. As shown, a portion of a lower periphery of face shield 30 includes clear portion 20. Again, clear portion 20 can be composed of structural material which is similar to the upper portion of face shield 30 to provide protection from flying debris or similar hazards.

A user can be engaged in an occupational setting which mandates the use of a face shield 30. The occupational setting can be in a bright, sunlit environment or similar. For example, the user can be operating a control panel in a room with extremely bright overhead lighting. The control panel can include LCD displays or similar screens with generally dimmer backlighting. The user can enjoy the filtration of light from the overhead lighting while operating the control panel yet also receive the benefit of substantially unobstructed viewing of the LCD panel through clear portion 20. Again, the associated tint of the upper portion of face shield 30 can be selected to fit a particular need. The tint can vary in color or in transparency.

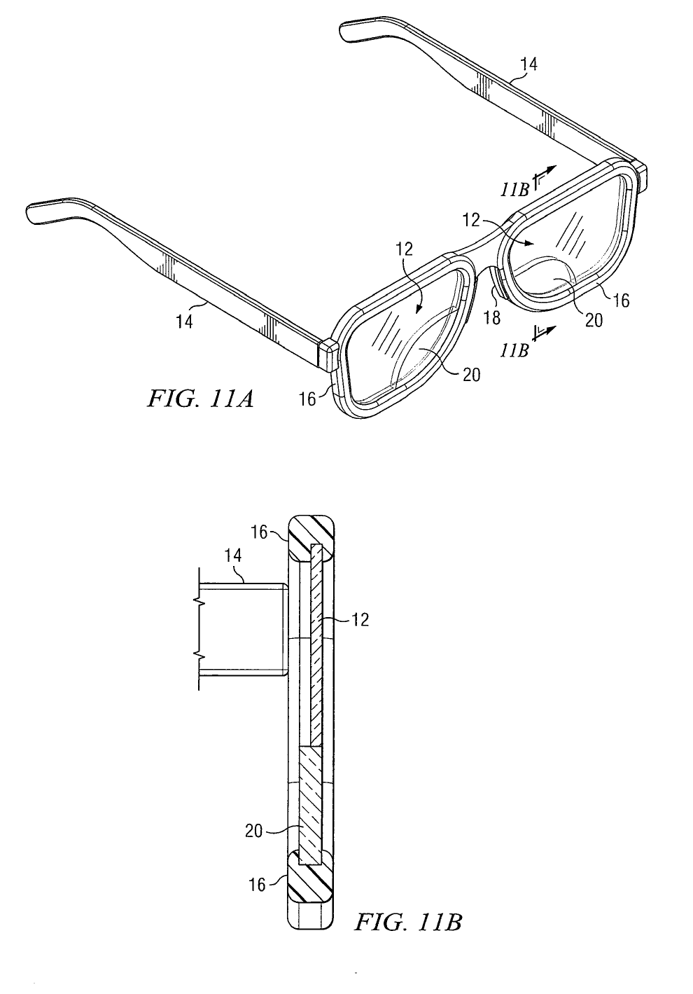

Turning to FIG. 11A, an additional embodiment, according to the present invention, is depicted. Again, two semitransparent sunglass lenses 12 are shown mounted to frames 16 having arms 14 as shown. Frames 16 completely enclose a side surface of the lenses 12 as shown. Frames 16 are shown having an integrated nosepiece 18.

Sunglass lenses 12 can extend from a top surface of the frame to a position corresponding to a location just below the pupil of the eye of a wearer. A distinct separation line is shown which separates the sunglass lenses 12 from a refractive lens 20, which is shown coupled to the sunglass lenses 12 at the distinct separation line.

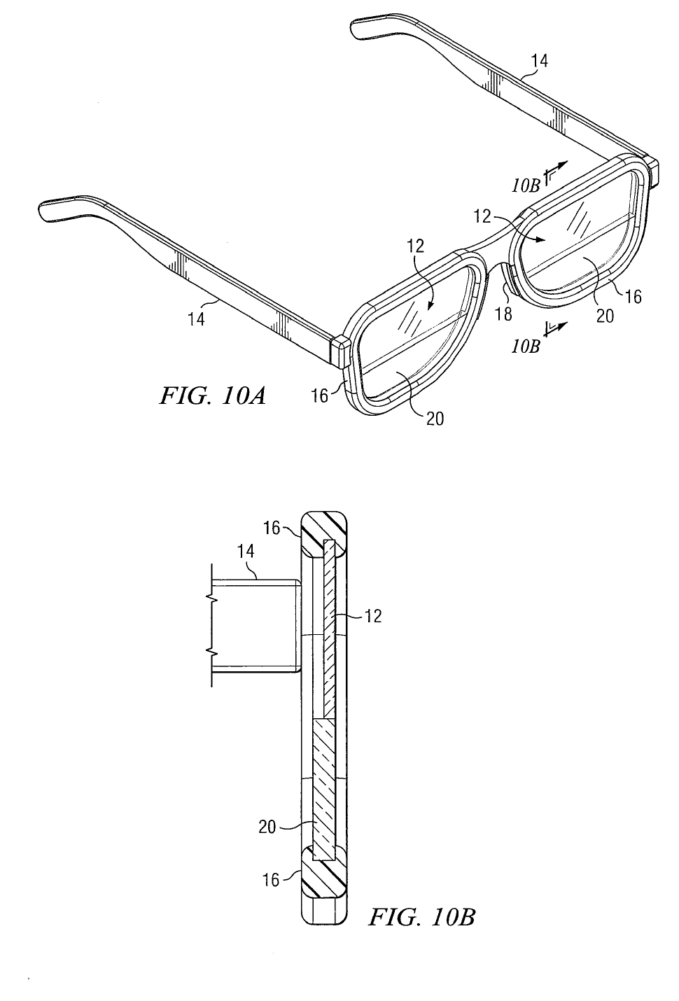

A more detailed view of the distinct separation lined junction between lens 12 and lens 20 is shown in FIG. 10B. A side surface of lens 12 is shown encased by a portion of frames 16. Refractive lens 20 is shown thicker than sunglass lens 12 in order to accomplish an appropriate refraction of light for a particular embodiment. The combination of refractive lens 20 and sunglass lens 12 is encased by the portion of the frames 16 to provide structural support.

The distinct separation zone (again, shown as the junction between lenses 12 and 20) can take a straight-lined path from a position corresponding to the nosepiece/lenses junction and extending horizontally in a straight line fashion as shown.

In one embodiment, lenses 12 and 20 can be formed from a single piece of material, yet be shaped and configured for the sunglass portion 12 to exhibit light absorbing or reflecting properties, and the refractive portion 20 to exhibit refractive properties, for example, incorporating a lens curvature subject to an eyeglass lens prescription. In addition, the refractive lens 20 or refractive portion 20 can correspond to a diopter unit of measurement of refraction, such as +1, +1.5, etc.

In another embodiment, the distinct separation zone can follow a curved path which originates at a position corresponding to the nosepiece and terminating at a position corresponding to a bottom portion of the frame. Turning to FIG. 11A, the distinct separation zone is depicted following such a curved path from the nosepiece to a portion located approximately halfway between the bottom surface of the frames 16. The separation zone between lenses 12, and lenses 20, or between lens portions 12, and lens portions 20, can be adapted in shape, width, length, or height to suit a particular application. A separation zone may follow a rectangular, or square path, for example, by originating at the nosepiece position shown in FIG. 11A, extending to substantially the center of the lens portions 12/20, and extending vertically to the middle position of the frames 16 bottom surface as shown in FIG. 11A.

Again, in FIG. 11B, the separation zone can physically join two separate lenses 12, and lenses 20, or form a junction between a single lens portion 12 and lens portion 20. Here again, the portion of the frames 16 encases a side surface of either lenses 12 and lenses 20 or a side surface of portion 12 and portion 20 to provide structural support.

Sunglass lens 12 or lens portion 12 can again incorporate such features as the sunglass-type lenses discussed previously, such as including gray, green, brown, amber, yellow, vermillion, orange, or red tints for a particular application. Lens 12 can be selected to block or absorb 70 to 90 percent of light, and/or incorporate a polarizing filter for filtering light reflecting off a horizontal surface.

The embodiments depicted in FIGS. 10A, 10B, 11A, and 11B allow for a user to enjoy the light reflective and absorptive properties of a sunglass lens in a particular field of view, while also enjoying the light refractive and corrective properties of a refractive lens, so as to continue to view objects which are close to the wearer.

While one or more embodiments of the present invention have been illustrated in detail, the skilled artisan will appreciate that modifications and adaptations to those embodiments may be made without departing from the scope of the present invention as set forth in the following claims.

What is claimed is:

1. A multipart sunglass device, comprising:
a frame including an integrated nosepiece;
a semitransparent sunglass lens mounted to the frame, the frame completely enclosing a side surface of the sunglass lens, wherein the sunglass lens extends vertically from a top surface of the frame to a first position corresponding to a location just below the pupil of the eye of a wearer; and
a transparent, refractive lens coupled to a bottom surface of the sunglass lens corresponding with the first position, wherein the sunglass lens and the refractive lens are joined at a distinct separation zone, allowing the wearer to view objects having a focal position lower than the first position without any obstruction, filtration or absorption of light, yet view the objects subject to a refractive property of the refractive lens.

2. The device of claim 1, wherein the distinct separation zone follows a straight-lined path separating the sunglass lens with the refractive lens at the first position.

3. The device of claim 1, wherein the distinct separation zone follows a curved path originating from a second position corresponding to the nosepiece of the frame and terminating at a third position corresponding to a bottom portion of the frame.

4. The device of claim 1, wherein the sunglass lens incorporates a gray, green, brown, amber, yellow, vermillion, orange, or red tint.

5. The device of claim 1, wherein the refractive lens corresponds to a diopter unit of measurement for a particular application.

6. The device of claim 1, wherein the refractive lens incorporates a lens curvature corresponding to a lens prescription.

7. A multipart sunglass device, comprising:
a frame and nosepiece apparatus; and
a sunglass lens having a semitransparent portion and a clear, refractive portion, the sunglass lens mounted to the frame, wherein the semitransparent portion of the sunglass lens
is selected to block or absorb 70 to 90 percent of light,
incorporates a polarizing filter for filtering light reflecting off a horizontal surface, and
extends vertically from a top surface of the frame to terminate at a first position corresponding to a location just below the pupil of the eye of a wearer,
and the clear, refractive portion
extends vertically from the first position to a bottom surface of the frame, the clear refractive portion and semitransparent portion joined at a distinct separation zone to allow the wearer to view objects having a focal position lower than the first position without any obstruction, filtration or absorption of light, yet view the objects subject to a refractive property of the clear, refractive portion of the sunglass lens.

8. The device of claim 7, wherein the distinct separation zone follows a straight-lined path separating the semitransparent portion of the sunglass lens with the clear, refractive portion of the sunglass lens at the first position.

9. The device of claim 7, wherein the distinct separation zone follows a curved path originating from a second position corresponding to the nosepiece of the frame and terminating at the bottom surface of the frame.

10. The device of claim 7, wherein the semitransparent portion of the sunglass lens incorporates a gray, green, brown, amber, yellow, vermillion, orange, or red tint.

11. The device of claim 7, wherein the clear, refractive portion of the sunglass lens corresponds to a diopter unit of measurement for a particular application.

12. The device of claim 7, wherein the clear, refractive portion of the sunglass lens incorporates a lens curvature corresponding to a lens prescription.

13. A multipart sunglass device, comprising:
a frame connected to a nosepiece;
a sunglass lens mounted to the frame and extending vertically from a top surface of the frame to a first position corresponding to a location just below the pupil of the eye of a wearer; and
a clear, refractive lens coupled to a bottom surface of the sunglass lens at the first position to form a distinct separation zone, allowing the wearer to view objects at a focal position lower than the first position without any obstruction, filtration or absorption of light, yet view the objects subject to a refractive property of the clear, refractive lens.

14. The device of claim 13, wherein the sunglass lens is constructed of a scratch-resistant polycarbonate material.

15. The device of claim 13, wherein the frame completely encloses a side surface of the sunglass lens.

16. The device of claim 13, wherein the distinct separation zone follows a straight-lined path separating the sunglass lens from the clear, refractive lens at the first position.

17. The device of claim 13, wherein the distinct separation zone follows a curved path originating from a second position corresponding to the nosepiece and terminating at the bottom surface of the frame.

18. The device of claim 13, wherein the sunglass lens incorporates a gray, green, brown, amber, yellow, vermillion, orange, or red tint.

19. The device of claim 13, wherein the clear, refractive lens of the sunglass lens corresponds to a diopter unit of measurement for a particular application.

20. The device of claim 13, wherein the clear, refractive lens incorporates a lens curvature corresponding to a lens prescription.

21. A method of manufacturing a multipart sunglass device, comprising:
providing a frame including an integrated nosepiece;
providing a semitransparent, polycarbonate sunglass lens mounted to the frame, the frame completely enclosing a side surface of the sunglass lens, wherein the sunglass lens extends vertically from a top surface of the frame to a first position corresponding to a location just below the pupil of the eye of a wearer; and
providing a transparent, refractive lens coupled to a bottom surface of the sunglass lens corresponding with the first position, wherein the sunglass lens and the refractive lens are joined at a distinct separation zone, allowing the wearer to view objects having a focal position lower than the first position without any obstruction, filtration or absorption of light, yet view the objects subject to a refractive property of the refractive lens.

22. The method of manufacture of claim 21, wherein the distinct separation zone follows a straight-lined path separating the sunglass lens with the refractive lens at the first position.

23. The method of manufacture of claim 21, wherein the distinct separation zone follows a curved path originating from a second position corresponding to the nosepiece of the frame and terminating at a third position corresponding to a bottom portion of the frame.

24. The method of manufacture of claim 21, wherein the sunglass lens incorporates a gray, green, brown, amber, yellow, vermillion, orange, or red tint.

25. The method of manufacture of claim 21, wherein the refractive lens corresponds to a diopter unit of measurement for a particular application.

26. The method of manufacture of claim 21, wherein the refractive lens incorporates a lens curvature corresponding to a lens prescription.
